(19) United States
(12) Patent Application Publication
(10) Pub. No.: US 2016/0282247 A1
(43) Pub. Date: Sep. 29, 2016

(54) SYSTEMS AND METHODS FOR DETERMINING AND MODIFYING STRESS CRACK PERFORMANCE IN CONTAINERS

(71) Applicant: AGR International, Inc., Butler, PA (US)

(72) Inventors: Georg V. Wolfe, Butler, PA (US); William E. Schmidt, Gibsonia, PA (US); Scott A. Mang, Pittsburgh, PA (US)

(21) Appl. No.: 15/069,408

(22) Filed: Mar. 14, 2016

Related U.S. Application Data
(60) Provisional application No. 62/137,684, filed on Mar. 24, 2015.
(60) Provisional application No. 62/137,609, filed on Mar. 24, 2015.

(51) Int. Cl. G01N 3/40

(52) U.S. Cl. CPC G01N 3/40

(57) ABSTRACT

Systems and methods determine and modify stress crack performance in containers. The method comprises the steps of receiving bottle yield pressure data describing a bottle yield pressure of a first container and receiving stress crack performance data describing a stress crack performance of a second container. The method further comprises the steps of determining a threshold bottle yield pressure based at least in part on the stress crack performance data and determining that the bottle yield pressure of the first container is less than the threshold bottle yield pressure. The method further comprises the step of displaying an indication that the bottle yield pressure of the first container is less than the threshold bottle yield pressure.

### PRIORITY

This application claims the benefit of U.S. Provisional Application Ser. No. 62/137,684, filed on Mar. 24, 2015, which is incorporated herein by reference in its entirety. This application also claims the benefit of U.S. Provisional Application Ser. No. 62/137,609, filed on Mar. 24, 2015, which is also incorporated herein by reference in its entirety.

### BACKGROUND

Polyethylene terephthalate (PET) and other types of plastic containers are commonly produced utilizing a machine referred to as a reheat, stretch and blow molder. The blow molder receives preforms and outputs containers. When a preform is received into a blow molder, it is initially heated and placed into a mold. A rod stretches the preform while air is being blown into the preform causing it to stretch axially and circumferentially, and take the shape of the mold. A typical reheat, stretch and blow molder has between ten (10) and forty-eight (48) or more molds. This increases the product rate of the blow molder, but also increases the rate at which defective containers can be generated when there is a problem with one or more blow molding process parameters. Accordingly, container manufacturers are keen to detect and correct blow molding process problems as efficiently as possible.

### SUMMARY

In one general aspect, the present invention is directed to systems and methods for determining and modifying stress crack performance in containers, such as blow-molded PET containers. The method comprises the steps of receiving bottle yield pressure data describing a bottle yield pressure of a first container and receiving stress crack performance data describing a stress crack performance of a second container. The method further comprises the steps of determining a threshold bottle yield pressure based at least in part on the stress crack performance data and determining that the bottle yield pressure of the first container is less than the threshold bottle yield pressure. The method further comprises the step of displaying an indication that the bottle yield pressure of the first container is less than the threshold bottle yield pressure.

### FIGURES

Various embodiments are described herein by way of example in conjunction with the following figures, wherein:

FIG. 1 is a block diagram showing one embodiment of a blow molder system.

FIG. 2 is a diagram showing one example of a pressure testing device that may be used to determine the stress crack performance of a container, for example, based on a measured bottle yield pressure.

FIG. 3 is a diagram showing one example of an environment for determining and/or modifying stress crack performance in containers.

FIG. 4 is a flow chart showing one example of a process flow for measuring the stress crack performance of a container.

FIG. 5 is a flow chart showing one example of a process flow for measuring stress crack performance of a container.

FIG. 6 is a flow chart showing one example of a process flow for optimizing the stress crack performance of containers created by a blow molder system, such as the system shown in FIG. 1.

### DESCRIPTION

Stress cracks typically occur in the base area of PET containers that are formed in the re-heat blow molding process, such as, for example, carbonated soft-drink containers. Stress cracks have been a problem for the container industry since the removal of the base cups on the containers. Stress cracking may occur due to rapid degradation of the PET molecular structure in a container when the container comes into contact with certain chemical reagents. When stress cracks occur, containers often leak, resulting in the loss of product. Attempts in the industry to mitigate this problem have included changing the chemical reagents that might contact the base of the container and attempting to keep particularly sensitive areas of the container base from making contact with the chemicals.

Various quality testing methods are currently used to determine the susceptibility of containers to stress cracking. One example of such a testing method is found in the International Society of Beverage Technologists (ISBT) Test Method for Evaluating the Relative Stress Crack Resistance of Poly(ethylene terephthalate) Carbonated Soft Drink Bottles (PTC-Stress Crack Test Methods 031207), which is incorporated herein by reference in its entirety. The method set forth (referred to herein as the ISBT method) involves placing filled and pressurized containers (531+/−4 kilopascals (77+/−0.5 psi)) in a Sodium Hydroxide (NaOH) bath and measuring the time until container failure, where container failure is indicated by the release of pressure. Depending on the properties of the tested container, stress cracks may develop in as little as a few minutes, although sometimes it may take more than a half an hour. Various examples described herein are directed to quicker methods for determining the stress crack performance of containers as well as systems and methods for managing parameters of a blow molder to maximize stress crack performance.

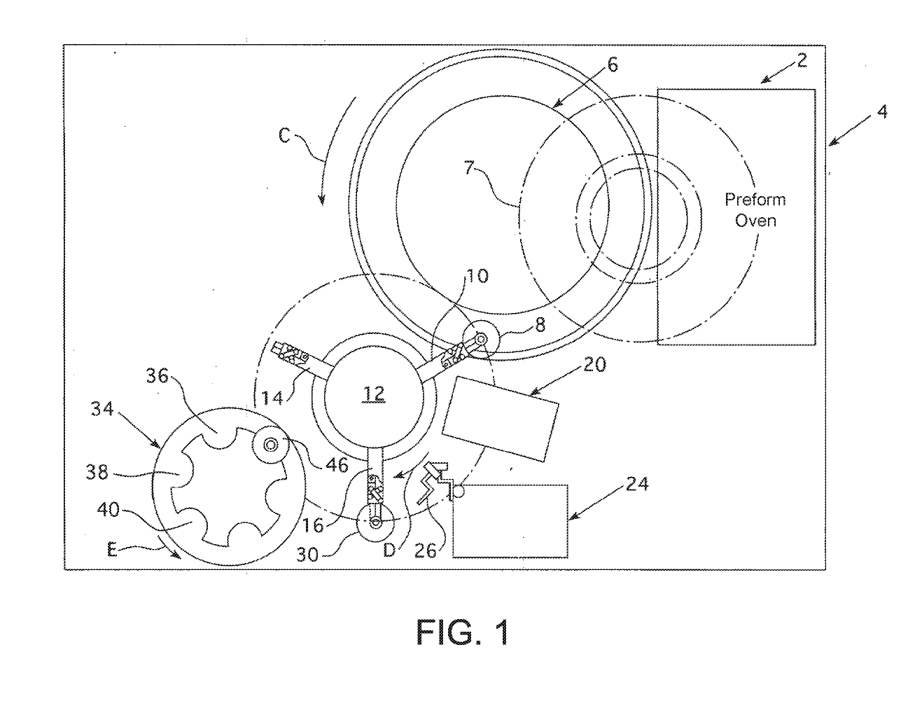

Before describing the control systems and methods in more detail, an overview of a blow molder system is provided. FIG. 1 is a block diagram showing one embodiment of a blow molder system 4 according to various embodiments. The blow molder system 4 includes a preform oven 2 that typically carries the plastic preforms on spindles through the oven section so as to preheat the preforms prior to blow-molding of the containers. The preform oven 2 may comprise, for example, infrared heating lamps or other heating elements to heat the preforms above their glass transition temperature. Many blow molders 6 utilize preform ovens defining multiple heating elements positioned to heat different portions of the preforms. The preforms leaving the preform oven 2 may enter the blow molder 6 by means, for example, of a conventional transfer system 7 (shown in phantom).

The blow molder 6 may comprise a number of molds, such as on the order of ten to twenty-four, for example, arranged in a circle and rotating in a direction indicated by the arrow C. The preforms may be stretched in the blow molder 6, using air and/or a core rod, to conform the preform to the shape defined by the mold. In many blow molders 6, an initial pre-blow is utilized to begin the container formation process followed by a high-pressure blow to push the now-stretched walls of the preform against the mold. Depending on the type of container to be generated, the molds may be heated (a hot mold process) or cooled (a cold mold process). Containers emerging from the blow molder 6, such as container 8, may be suspended from a transfer arm 10 on a transfer assembly 12, which is rotating in the direction indicated by arrow D. Similarly, transfer arms 14 and 16 may, as the transfer assembly 12 rotates, pick up the container 8 and transport the container through the inspection area 20, where it may be inspected by one or more of the inspection systems described below. A reject area 24 has a reject mechanism 26 that may physically remove from the transfer assembly 12 any containers deemed to be rejected. In some embodiments, the blow molder system 4 may include alternate inspection areas.

In the example of FIG. 1, container 30 has passed beyond the reject area 24 and may be picked up in a star wheel mechanism 34, which is rotating in direction E and has a plurality of pockets, such as pockets 36, 38, 40, for example. A container 46 is shown in FIG. 1 as being present in such a star wheel pocket. The containers may then be transferred in a manner known to those skilled in the art to a conveyer or other transport mechanism according to the desired transport path and nature of the system. It will be appreciated that the blow molder system 4 may comprise one or more inspection areas in addition to or instead of the inspection area 20. For example, alternate inspection areas may be created by adding additional transfer assemblies, such as transfer assembly 12. Also, alternate inspection areas may be positioned on a conveyor or other position down-line from the blow molder 6.

Examples of the blow molder system 4 may produce containers at a rate of 20,000 to 120,000 per hour, though manufacturers continue to develop blow molders with increasing speed and in some embodiments it may be desirable to run the blow molder system 4 at lower rates. The blow molder system 4 receives various inputs parameters that affect the characteristics of the generated containers. For example, the preform oven 2 may receive an overall temperature input parameter, referred to as a preform temperature set point, as well as additional input parameters that define the distribution of heat between the individual heating elements. Other controllable parameters include, for example, a pre-blow timing, a pre-blow pressure, etc.

In various examples of PET and other containers, there may be a strong correlation between stress crack performance and the overall container performance. For example, decreasing the processing temperature in the blow molder system 4 may improve stress crack performance as well as the physical characteristics of the container. The processing temperature of the blow molder system 4 may be decreased, for example, by decreasing the preform temperature set point or other parameter of the preform oven 2. The inventors have found that as processing temperature decreases, container burst pressure increases, volume expansion at burst decreases, volume expansion after holding at a constant pressure decreases, time-to-stress crack increases and bottle yield pressure increases. Decreasing the processing temperature too much, however, can produce pearlescence in the container. Pearlescence is caused by stretching the fibers of the PET container at too cold a temperature, creating a whitening of the plastic in the areas with the highest stretch ratio. Example systems and methods for detecting pearlescence and optimizing the operation of the blow molder system 4 to minimize pearlescence are described in commonly-owned PCT Application Publication No. WO2015/023673, entitled, “Blow Molder Control Systems and Methods,” filed on Aug. 12, 2014, which is incorporated herein by reference in its entirety.

Various examples described herein are directed to systems and methods for determining the stress crack performance of a container by measuring a bottle yield pressure. Although the term bottle yield pressure is used herein, a bottle or container yield pressure is not limited to bottles only. A bottle or container yield pressure may be found for various other types of containers. This may allow stress crack performance to be measured without the need for caustic chemicals or time consuming chemical baths. Bottle yield pressure is a measure of the internal pressure at which a container no longer behaves in an elastic manner. For example, when a container is pressurized at or above its bottle yield pressure, the container may become misshapen and may not return to its original shape. In various examples, a bottle yield pressure measurement may be used to determine stress crack performance of a container quickly and without resorting to potentially time-consuming existing methods. For example, the inventors have found that bottle yield pressure is positively correlated with time-to-stress crack performance. Accordingly, as described herein, a correlation may be found between bottle yield pressure and an indication of stress crack performance, such as time-to-stress crack. A bottle yield pressure may found for a container. The measured bottle yield pressure may be converted to an indication of stress crack performance, for example, using the derived correlation.

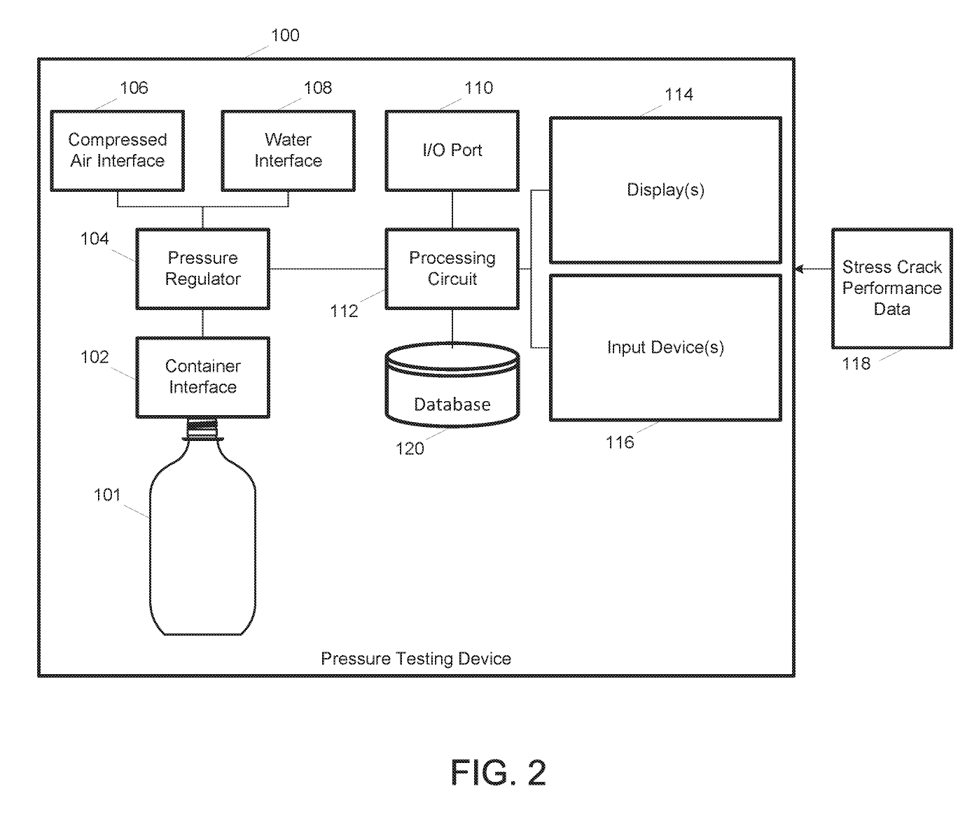

Various examples may measure bottle yield pressure utilizing a pressure testing device. A pressure testing device may be any suitable device for pressurizing a container and detecting the bottle yield pressure. One example of a pressure testing device is the PPT-3000 device available from AGR International Inc. of Butler, Pa. FIG. 2 is a diagram showing one example of a pressure testing device 100 that may be used to determine the stress crack performance of a container, for example, based on a measured bottle yield pressure. The pressure testing device 100 may comprise a container interface 102 shaped to interface with a container 101. For example, the container 101 may be threaded into a fitting of the container interface. The container interface 102 may be in fluid communication with a pressure regulator 104. The pressure regulator 104 may comprise one or more valves for controlling the flow of fluid into the container. The valves, in some examples, are under the control of one or more servos (not shown) that may be manipulated by the processing circuit 112 (described below). In some examples, the pressure regulator 104 may control the flow of multiple fluids into the container (e.g., air or another gas and water). For example, the pressure regulator 104 may be in fluid communication with a compressed air interface 106 and/or a water interface. The compressed air interface may receive pressurized air or another pressurized gas (e.g., nitrogen). Air or other gas received via the compressed air interface 106 may be pressured so as to maintain a suitable system pressure (e.g., 300-350 psi). The water interface 108 may receive water from a water source. The water source may also be pressurized (e.g., 20-60 psi).

The pressure regulator 104 may be in communication with the processing circuit 112. For example, the processing circuit 112 may control the operation of one or more valves at the pressure regulator to control the amount of fluid and/or pressure provided to the container 101. The processing circuit 112 may comprise any suitable control hardware including, for example, a processor, memory, a field programmable gate array (FPGA), etc. The processing circuit 112 may receive input from one or more input/output ports 110. The input/output ports 110 may comprise ports configured to receive data according to any suitable standard including, for example, Universal Serial Bus (USB), etc. The processing circuit 112 may also be in communication with one or more displays 114 and/or one or more input devices 116. Displays 114 may comprise any suitable screen, indicator lights, etc. Input devices 116 may include any suitable type of keyboard, touchpad, etc. In some examples, the pressure testing device 100 may comprise a touchscreen (not shown) that acts as both an input device and an output device.

In some examples, the pressure testing device 100, or other suitable pressure testing device, may find a bottle yield pressure for a container (e.g., the container 101) by conducting a ramp pressure test. According to the ramp pressure test, a fluid (e.g., water) is introduced into the container 101. The processing circuit 112 may ramp up the pressure of the container 101 at a constant rate (e.g., 10 psi/sec) from, for example, 0 psi until bottle yield occurs. While the pressure is ramped up, the volume of the container 101 may be monitored, for example, by tracking the amount of water or other fluid that is passed into the container 101. The processing circuit 112 may control the ramp-up of pressure to the container 101 and may detect the occurrence of bottle yield. For example, the processing circuit 112 may store the bottle yield pressure at an internal memory. The processing circuit 112 may identify the bottle yield pressure in any suitable manner. For example, the processing circuit 112 may identify the bottle yield pressure by locating the transition point from elastic to inelastic behavior in a plot of pressure (e.g., instantaneous pressure) versus volume expansion of the container, referred to herein as the pressure versus volume expansion plot. One example method for finding the transition point from elastic to inelastic behavior includes finding a maximum of the second derivative of the pressure versus volume expansion plot. However, any suitable method may be used. It will be appreciated that a ramp pressure test is just one way to measure bottle yield pressure and that any other suitable technique may be used.

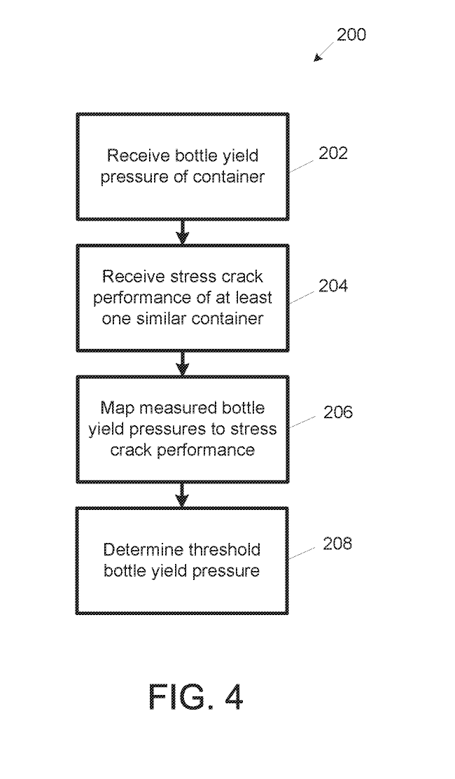

In some examples, the pressure versus volume expansion plot for a container may be analogous to a standard material stress-strain curve for ductile materials, albeit over the container as a whole. In a traditional stress-strain curve, however, stress pressure is applied in dimensional planes and the strain is measured as in-plane change in dimensions caused by the applied stress. Because bottle yield pressure is derived from an actual bottle with a complex, three-dimensional shape under continuously changing pressures from all directions, it may be analogous to a three-dimensional stress-strain curve or three-dimensional loading analysis describing the container. In some examples, as described herein below with respect to FIG. 4, the pressure testing device 100 may be used to correlate stress crack performance data 118 to bottle yield pressure to allow the pressure testing device to provide users with an indication of stress crack performance data based on a ramp pressure test or other pressure test. The pressure testing device 100 (e.g., the processing circuit 112 thereof) may receive the stress crack performance data 118 in any suitable manner including, for example, via an input device 116, from another computing device via an input port 110, etc. In some examples, stress crack performance data 118 may be stored at a database 120. The database 120 may comprise stress crack performance data 118 as well as bottle yield pressures measured by the device 100. In some examples, the database 120 may be utilized to derive and store a correlation between stress crack performance and bottle yield pressure, as described herein.

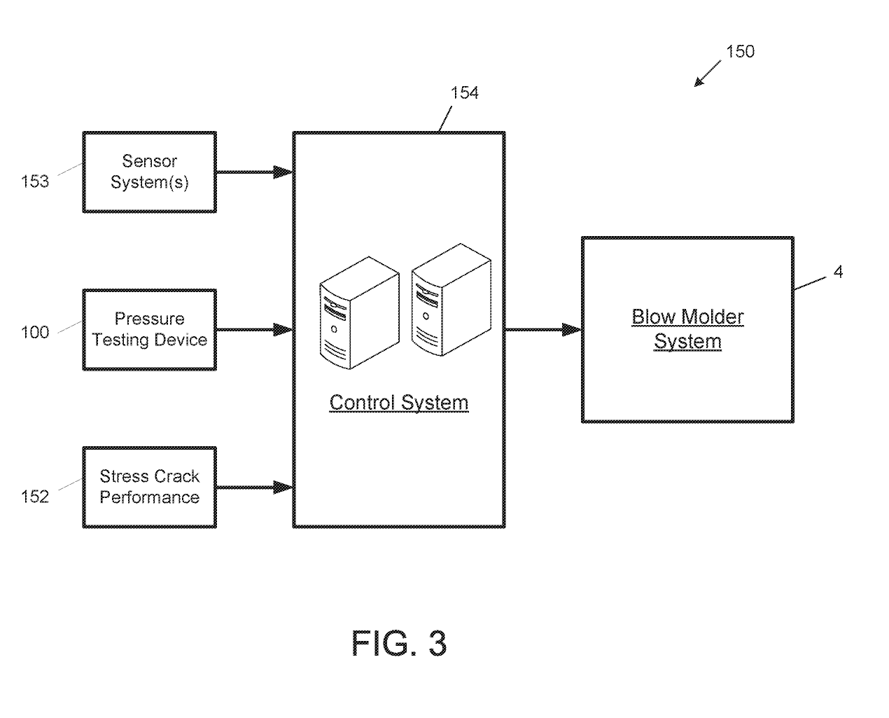

FIG. 3 is a diagram showing one example of an environment 150 for determining and/or modifying stress crack performance in containers. The environment 150 may comprise a blow molder control system 154, a pressure testing device 100 and a stress crack performance device 152. Optionally, the device 100 may also comprise a blow molder system 4, as described herein above. Optionally, the device 100 may also comprise one or more sensor systems 153 for sensing properties of containers. Sensor systems 153 may include, for example, machine vision camera systems, proximity sensors, temperature sensors, etc. that may be positioned online and/or for sample testing. Examples of sensor systems are provided in commonly-owned PCT Application Publication No. WO2015/023673 incorporated herein by reference in its entirety.

The pressure testing device 100 may be any suitable device or mechanism for measuring the bottle yield pressure, or similar value, of containers, for example, as described herein above in FIG. 2. The stress crack performance device 152 may be any device or testing apparatus used to directly measure the stress crack performance (e.g., time-to-stress crack) of containers. The blow molder control system 154 may comprise one or more processors, servers or other computer devices. The blow molder control system 154 may receive data from the pressure testing device 100 and/or the stress crack performance device 152 indicating the results of pressure testing and stress crack performance testing. The data may be received in any suitable manner. For example, the data from one or more of the devices 100, 152 may be received in electronic format via any suitable wired or wireless connection. In some examples, the data may be received via a wired and/or wireless network and/or a dedicated bus or busses. In some examples, electronic data from the pressure testing device 100 and/or the blow molder control system 154 may be manually entered to the control system by a human user. In some examples, the blow molder control system 154 may also modify parameters of the blow molder system 4, as described herein, to optimize the stress crack performance of containers.

FIG. 4 is a flow chart showing one example of a process flow 200 for measuring the stress crack performance of a container. The process flow 200 may be executed at any suitable stage of container design and/or production. The process flow 200 is described herein as being executed by the processing circuit 112 of the pressure testing device 100. In some examples, however, the process flow 200 may be executed by other various components including, for example, the blow molder control system 154 of the environment 150 of FIG. 3.

In some examples, the process flow 200 may be executed during the design of a container to determine the stress crack performance of different container shapes, sizes, etc. Also, in some examples, the process flow 200 may be executed for various unique combinations of container material (e.g., resin) and design. At 202, the processing circuit 112 may receive bottle yield pressures for one or more containers. For example, the processing circuit 112 may manage ramp pressure testing or other suitable testing to find the bottle yield pressure for a container. In some examples, a population including multiple containers may be tested and the processing circuit 112 may receive and/or store bottle yield pressures over the population of containers. For example, the population of containers may comprise or consist of containers having a common design (e.g., shape and/or material). The processing circuit 112 may receive for each tested container a processing temperature at which the container was blown. Data including, for example, measured bottle yield pressures and corresponding processing temperatures may be stored, for example, as the database 120.

At 204, the processing circuit 112 may receive stress crack performance data describing at least one container similar to the container measured at 202. For example, the stress crack performance data may be the result of testing on a container or containers having the same design (e.g., shape and/or material) as the container measured at 202. Stress crack performance data may be found using any suitable technique. For example, stress crack performance data may be and/or include time-to-stress crack results found according to the ISBT test method described herein. In some examples, if the bottle yield pressure is found at 202 for a population of containers, the stress crack performance data received at 204 may be found for a similar or identical population of containers (e.g., a set of containers having the same or similar designs made over a similar range of blow molder operating conditions). In some examples, the order of 202 and 204 may be reversed. Stress crack performance data may be received, for example, through an input device 116 of the pressure testing device. In some examples, the stress crack performance data received for each container may also indicate a processing temperature at which the container was blown. In some examples, stress crack performance data including corresponding processing temperatures may be stored at the database 120.

At 206, the processing circuit 112 may map measured bottle yield pressures to the received stress crack performance data. The stress crack performance values may be used as calibration points relating stress crack performance to bottle yield pressure. For example, measurements for containers blown at the same or similar processing temperatures may be considered equivalent. In some examples, the processing circuit 112 may derive stress crack performance data that corresponds to measured bottle yield pressures. Accordingly, as described herein, the pressure testing device 100 may be programmed, as described herein, to output a stress crack performance value based on pressure testing. The mapping may be performed in any suitable manner. In some examples, the processing circuit 112 may generate a look-up table including bottle yield pressures and corresponding stress crack performance values (e.g., time-to-stress crack). In some examples, the processing circuit 112 may approximate a curve that fits a relationship between bottle yield pressures and stress crack performance. The resulting curve may provide an equation that can be used to convert bottle yield pressure values to stress crack performance values. In various examples, a mapping between stress crack performance and bottle yield pressure may be consistent for containers having the same design and resin selection.

Optionally, at 208, the processing circuit 112 may find a threshold bottle yield pressure. The threshold bottle yield pressure may be a minimum bottle yield pressure at which acceptable stress crack performance can be achieved. For example, the processing circuit 112 may receive an indication of a minimum acceptable stress crack performance value for the container (e.g. a time-to-stress crack less than a threshold value, such as between 2 and 20 minutes, between 5 and 10 minutes, etc.). The processing circuit 112 may convert the minimum stress crack performance value to a corresponding bottle yield pressure. The determined bottle yield pressure may be the threshold bottle yield pressure. In some examples, a bottle yield pressure of 100 psi may indicate stress crack performance below an acceptable performance (e.g., less than 5 minutes) and a bottle yield pressure of 220 psi may indicate a stress crack performance within acceptable criteria (greater than 20 minutes).

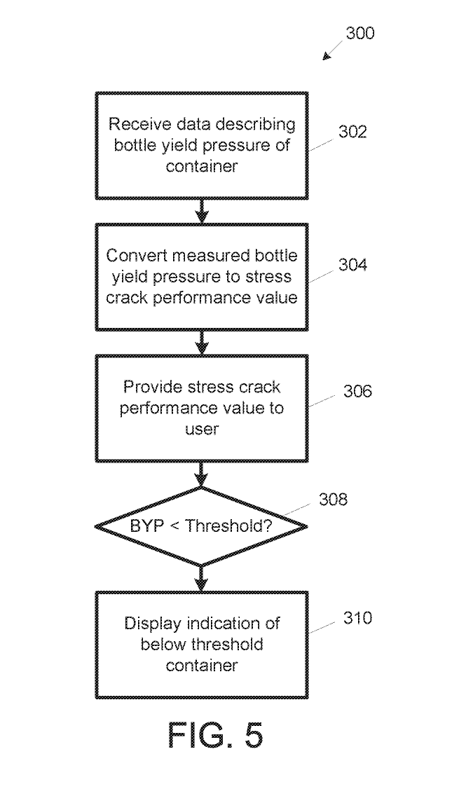

FIG. 5 is a flow chart showing one example of a process flow 300 for measuring stress crack performance of a container. The process flow 300 is described herein as being executed by the processing circuit 112 of the pressure testing device 100. In various examples, however, the process flow 300 may be executed, for example, by any other suitable component including, for example, the blow molder control system 154 of the environment 150 of FIG. 3.

At 302, the processing circuit 112 may receive data describing a bottle yield pressure of a container. The bottle yield pressure may be measured in any suitable manner, including, for example, using a ramped pressure test as described herein. At 304, the processing circuit 112 may convert the measured bottle yield pressure to a stress crack performance value such as, for example, a time-to-stress crack. In some examples, the processing circuit 112 may conduct the conversion utilizing the mapping generated, as described herein with respect to FIG. 4. Optionally, at 306, the processing circuit 112 may provide the stress crack performance value to a user. The value may be provided to a user in any suitable manner. For example, the value may be provided at a display 114 of the pressure testing device 100. Also, in some examples, the processing circuit 112, blow molder control system 154, or other suitable component may write the stress crack performance value to a database or other central location where it may be accessed by other applications and/or devices.

Optionally, the processing circuit 112 may determine if the bottle yield pressure is below a threshold bottle yield pressure, at 308. The threshold bottle yield pressure, as described herein, may be a bottle yield pressure below which the container may have unacceptable stress crack performance values. Determining whether the bottle yield pressure is below the threshold bottle yield pressure may comprise comparing the bottle yield pressure received at 302 with a threshold bottle yield pressure and/or converting the bottle yield pressure to a stress crack performance value and comparing the stress crack performance value to a threshold. If the bottle yield pressure is less than the threshold at 306, then the processing circuit 112 may display an indication that the measure container has less than acceptable stress crack performance at 310.

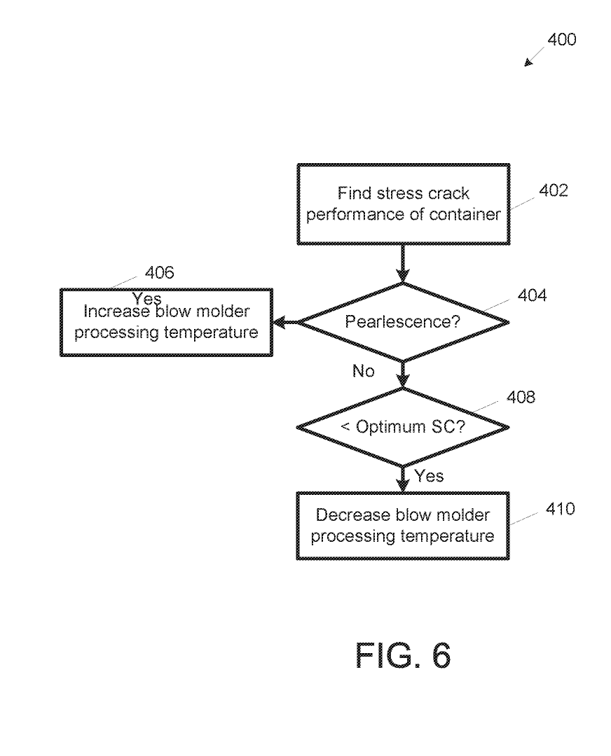

In various examples, the stress crack performance of containers may be optimized by modifying operating parameters of the blow molder system 4. FIG. 6 is a flow chart showing one example of a process flow 400 for optimizing the stress crack performance of containers created by a blow molder system, such as 4. The process flow 400 may be performed, for example, by one or more operators of the blow molder system 4 and may utilize the pressure testing device 100. At 402, the operator may find the stress crack performance of one or more containers generated by the blow molder system 4 using, for example, the pressure testing device 100 as described herein with respect to the process flow 200. Because a pressure test may be completed in a matter of seconds, it may be possible for the operator to incorporate resulting values for stress crack performance into the operation of the blow molder fast enough to correct blow molder errors. For example, the process flow 400 may be utilized when it is not possible or desirable to use other stress crack testing methods, for example, as outlined in ISBT methods.

At 404, the operator may determine whether the container includes pearlescence. Pearlescence may be detected in any suitable manner. For example, the operator may visually observe the container to see if pearlescence is visible. Also, in some examples, the operator may utilize a machine vision detector for pearlescence, for example, as described in PCT Application Publication No. WO2015/023673, incorporated herein by reference. If pearlescence is present, the operator may increase the processing temperature of the blow molder system 4. If no pearlescence is present, the operator may determine, at 408, whether the stress crack performance of the measured container or containers is less than optimum. In some examples, the operator may manually compare a measured stress crack performance to an optimum threshold. Also, in some examples, the pressure testing device 100 and/or other component of the environment 150 may be configured to provide an indication of whether measured stress crack performance values meet the optimum threshold. If the stress crack performance of the container is less than optimum, then the operator may decrease the blow molder processing temperature at 410. In this way, stress crack performance may be optimized by adjusting the blow molder system 4 processing temperature to a point just before the creation of pearlescence. The operator may adjust the processing temperature by any suitable increment. For example, some blow molder systems 4 may allow operating temperature (e.g., preform temperature set point) to be incremented in units of one degree. Accordingly, the operator may increment (406) or decrement (410) the operating temperature by one degree. Other blow molder systems 4 may allow adjustment by other increments (e.g., one tenth of one degree). In some examples, the operator may increment (406) or decrement (410) the operating temperature by the smallest increment supported by the relevant blow molder system 4.

When the maximum bottle yield pressure is achieved without creating pearlescence in the container, the risk of container stress cracking may be mitigated for the container design and resin selection. For example, the optimum bottle yield pressure may occur at the coldest possible processing temperature without pearlescence and the best possible stress crack performance may occur at the same coldest possible processing temperature.

The process flow 400 may be repeated at any suitable interval. For example, if pearlescence is detected at 404 and/or the stress crack performance is less than optimum, the process flow 400 may be repeated until one or both of those conditions is remedied. If the stress crack performance is optimum and no pearlescence is present, then the process flow 400 may be repeated periodically to verify the performance of the system and correct for drift.

In some examples, the process flow 400 may be executed by the blow molder control system 154 of the environment 150 described herein. For example, the blow molder control system 154 may receive stress crack performance data from the pressure testing device 100 described herein. The blow molder control system 154 may drive the processing temperature of the blow molder system 4 to optimize the stress crack performance data received from the pressure testing device 100. Also, in some embodiments, the blow molder control system 154 may be programmed to drive the processing temperature of the blow molder system 4 to or close to the onset of pearlescence. For example, the blow molder control system 154 may detect the onset of pearlesence from one or more sensors (e.g., sensor systems 153) and drive the processing temperature to a point slightly above the onset of pearlesence, for example, as described in PCT Application Publication No. WO2015/023673, incorporated herein by reference. This may provide real-time automated control of the blow molder system 4, driving the blow molder system 4 to maintain optimal values for stress crack performance.

The examples presented herein are intended to illustrate potential and specific implementations of the embodiments. It can be appreciated that the exemplary embodiments are intended primarily for purposes of illustration for those skilled in the art. No particular aspect or aspects of the examples is/are intended to limit the scope of the described embodiments.

As used in the claims, the term “plastic container(s)” means any type of container made from any type of plastic material including, polyethylene terephthlat (PET), oriented polypropolyene (OPP), etc.

It is to be understood that the figures and descriptions of the embodiments have been simplified to illustrate elements that are relevant for a clear understanding of the embodiments, while eliminating, for purposes of clarity, other elements. For example, certain operating system details and power supply-related components are not described herein. Those of ordinary skill in the art will recognize, however, that these and other elements may be desirable in inspection systems as described hereinabove. However, because such elements are well known in the art and because they do not facilitate a better understanding of the embodiments, a discussion of such elements is not provided herein.

In general, it will be apparent to one of ordinary skill in the art that at least some of the embodiments described herein may be implemented in many different embodiments of software, firmware and/or hardware. The software and firmware code may be executed by a processor (such as a processor of the blow molder control system 154 or processing circuit 112, etc.) or any other similar computing device. The software code or specialized control hardware which may be used to implement embodiments is not limiting. The processors and other programmable components disclosed herein may include non-transitory memory for storing certain software applications used in obtaining, processing and communicating information. It can be appreciated that such non-transitory memory may be internal or external with respect to operation of the disclosed embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable media.

In various embodiments disclosed herein, a single component may be replaced by multiple components and multiple components may be replaced by a single component, to perform a given function or functions. Except where such substitution would not be operative, such substitution is within the intended scope of the embodiments. For example, processor 142 may be replaced with multiple processors.

While various embodiments have been described herein, it should be apparent that various modifications, alterations and adaptations to those embodiments may occur to persons skilled in the art with attainment of at least some of the advantages. The disclosed embodiments are therefore intended to include all such modifications, alterations and adaptations without departing from the scope of the embodiments as set forth herein.

We claim:

1. A method comprising:
receiving bottle yield pressure data describing a bottle yield pressure of a first container;
receiving stress crack performance data describing a stress crack performance of a second container;
determining a threshold bottle yield pressure based at least in part on the stress crack performance data;
determining that the bottle yield pressure of the first container is less than the threshold bottle yield pressure; and
displaying an indication that the bottle yield pressure of the first container is less than the threshold bottle yield pressure.
